(19) United States
(12) Patent Application Publication
(10) Pub. No.: US 2024/0200866 A1
(43) Pub. Date: Jun. 20, 2024

(54) DEVICE FOR LIQUEFYING GASEOUS DIHYDROGEN FOR OFFSHORE OR ONSHORE STRUCTURE

(71) Applicant: GAZTRANSPORT ET TECHNIGAZ, Saint Remy Les Chevreuse (FR)

(72) Inventors: Bernard AOUN, Saint Remy Les Chevreuse (FR); Pavel BORISEVICH, Saint Remy Les Chevreuse (FR)

(73) Assignee: GAZTRANSPORT ET TECHNIGAZ, Saint Remy Les Chevreuse (FR)

(21) Appl. No.: 18/555,975

(22) PCT Filed: Apr. 14, 2022
(86) PCT No.: PCT/FR2022/050701

§ 371 Date: Oct. 18, 2023

(30) Foreign Application Priority Data
Apr. 21, 2021 (FR) 2104153

(51) Int. Cl. F25J 1/00; F25J 1/02

(52) U.S. Cl. CPC F25J 1/001; F25J 1/023; F25J 1/0277; F25J 2205/82

(57) ABSTRACT

A device for liquefying gaseous dihydrogen resulting from the evaporation of dihydrogen in the liquid state stored in a tank includes: a heat exchanger, a feed branch configured to convey a portion of the gaseous dihydrogen from the tank to a gaseous dihydrogen consumer, a part of the feed branch passing through the heat exchanger inside of which is placed a catalyst that is involved in the conversion of the parahydrogen to orthohydrogen, and a cooling branch including a compression member; a portion of the cooling branch passing through the heat exchanger exchanges heat with the first pass in order to liquefy a portion of the dihydrogen circulating in the cooling branch and to heat the dihydrogen circulating in the feed branch.

The present invention relates to the field of floating structures or onshore structures of which at least one consumer is supplied with dihydrogen. These structures make it possible to store and/or transport dihydrogen in the liquid state. It relates more particularly to a device for liquefying gaseous dihydrogen used as fuel for the at least one consumer of a structure, in particular a floating or onshore structure.

In order to transport and/or store dihydrogen more easily, the dihydrogen is generally in the liquid state having been cooled to cryogenic temperatures lower than the vaporization temperature of the dihydrogen at atmospheric pressure. The dihydrogen is, for example, cooled to −253° C. at atmospheric pressure so as to transition to the liquid state. This liquefied dihydrogen is then loaded into dedicated tanks of the structure.

However, such tanks are never perfectly thermally insulated, such that natural evaporation of the dihydrogen in the liquid state is inevitable. The natural evaporation phenomenon is called boil-off and the gas resulting from this natural evaporation is called boil-off gas, for which the acronym is BOG. The tanks of the structure thus comprise both dihydrogen in liquid form and dihydrogen in gaseous form.

One part of the dihydrogen present in the tank in gaseous form may be used to supply a consumer, such as a fuel cell, provided to meet the operating energy requirements of the structure, in particular for its propulsion and/or the production of electricity for the equipment on board the structure. Another part of the dihydrogen in gaseous form may be reliquefied in order to limit the increase in pressure inside the tank instead of using the vent and thus losing dihydrogen.

These liquefaction devices have the drawback of being complex and difficult to implement in particular as a result of the properties of the dihydrogen. The liquefaction efficiency is low, such that transporting dihydrogen in the liquid state remains expensive and not very profitable.

The aim of the present invention is to overcome at least one of the drawbacks mentioned above and also to lead to other advantages by proposing a novel device for liquefying gaseous dihydrogen resulting from the evaporation of dihydrogen in the liquid state.

The present invention proposes a device for liquefying gaseous dihydrogen resulting from the evaporation of dihydrogen in the liquid state stored in at least one tank, the liquefaction device comprising at least one heat exchanger with a plurality of passes, at least one supply branch configured to bring at least a portion of the gaseous dihydrogen from the tank to a gaseous dihydrogen consumer, a part of the supply branch passing through the heat exchanger via a first pass inside which is disposed a catalyst involved in the conversion of the para isomer of the dihydrogen into ortho isomer of the dihydrogen, the liquefaction device comprising at least one cooling branch configured to liquefy at least a part of the gaseous dihydrogen, the cooling branch having at least one compression member, a portion of the cooling branch passing through the heat exchanger via a second pass disposed after the compression member, the second pass exchanging heat energy with the first pass in order to liquefy at least a part of the dihydrogen circulating in the cooling branch.

In the present invention, the liquefaction device is configured to implement, within a heat exchanger, exchanges of heat energy between gaseous dihydrogen at cryogenic temperatures that is intended to be used as fuel by a consumer and gaseous dihydrogen at cryogenic temperatures that is intended to be at least partially liquefied, the gaseous dihydrogen at cryogenic temperatures coming from one or more tanks. “Cryogenic” is understood to mean a temperature lower than −40° C., or even lower than −90° C., and preferably lower than −150° C.

The dihydrogen is in two forms called nuclear spin isomers, also called orthohydrogen and parahydrogen. Orthohydrogen is dihydrogen made up of molecules in which the two protons, one in each atom of the molecule, have spins that are parallel to and in the same direction as each other. Parahydrogen is dihydrogen made up of molecules in which the two protons, one in each atom of the molecule, have antiparallel spins.

Dihydrogen in the liquid state, i.e. for a temperature less than or equal to −253° C. at atmospheric pressure, is constituted of 99.8% parahydrogen. By contrast, at ambient temperature and thermal equilibrium, the dihydrogen is made up of approximately 75% orthohydrogen and 25% parahydrogen.

The enthalpy of the reaction of isomerization of the parahydrogen into orthohydrogen is equal to +525 KJ/kg, indicating an endothermic reaction. In comparison, the entropy of vaporization of the dihydrogen is only 476 KJ/kg. However, the reaction of isomerization of the parahydrogen into orthohydrogen is of the order of a few days. It is understood in this context that even if the dihydrogen is gaseous and at 25° C., the proportion of parahydrogen may still be very greatly predominant.

The gaseous dihydrogen resulting from the evaporation of dihydrogen stored in the liquid state in the tank is intended to be used as fuel by the consumer and circulates in a first pass of the heat exchanger. The first pass comprises a catalyst that makes it possible to accelerate the reaction of isomerization of the parahydrogen into orthohydrogen and therefore makes it possible to profit from the energy absorption capacity of the isomerization reaction during the exchange of heat energy with the second pass of the heat exchanger.

The gaseous dihydrogen at cryogenic temperatures that is intended to be liquefied passes through a compression member and then into the second pass of the heat exchanger so as to be liquefied there, at least in part.

In the second pass, the compressed gaseous dihydrogen gives up its heat energy to the gaseous dihydrogen present in the first pass. The gaseous dihydrogen that circulates in the first pass is isomerized rapidly in the presence of the catalyst, in addition to being heated, with the absorption of the heat energy received from the second pass. The compressed gaseous dihydrogen that circulates in the second pass is cooled until it condenses.

The liquefaction device thus makes it possible to put to profitable use the evaporation of the nominal cargo of dihydrogen in the liquid state stored in one or more tanks.

According to one embodiment, the catalyst is chosen from among gels of nickel, copper, iron or metal hydride, nickel, copper or iron films, iron, cobalt, nickel, chromium, manganese hydroxides, iron oxides, nickel-silicon complexes, an activated charcoal and/or at least one combination thereof.

According to one embodiment, the supply branch comprises at least one compression device arranged after an outlet of the first pass. In other words, the compression device is disposed between an outlet of the first pass and the dihydrogen consumer. Therefore, when the gaseous dihydrogen circulates in the supply branch, it passes through the compression device after having left the first pass of the heat exchanger and before reaching the consumer. The compression device makes it possible in particular to place the gaseous dihydrogen in forced circulation in the supply branch, the pressure of the dihydrogen optionally also being high.

According to one embodiment, another portion of the cooling branch passes through the heat exchanger via a third pass, an outlet of the third pass being connected to an inlet of the second pass by a connecting portion of the cooling branch, the connecting portion comprising the compression member. Thus, when the dihydrogen circulates in the cooling branch, it passes through the third pass of the heat exchanger, then it passes through the compression device and then it passes through the second pass of the heat exchanger so as to be liquefied there, at least partially.

According to one embodiment, the second pass of the heat exchanger is arranged so as to exchange heat energy with the first pass and the third pass of the heat exchanger.

According to one embodiment, the liquefaction device comprises a gas-liquid separator arranged on the cooling branch after an outlet of the second pass. When the dihydrogen circulates in the cooling branch after having successively left the third pass and then the second pass of the heat exchanger, the dihydrogen may not be completely liquefied. Thus, it may be in the form of a two-phase fluid, i.e. a part of the dihydrogen is in liquid form and a part in gaseous form after having passed through the second pass, the two phases then being mixed. The gas-liquid separator will in particular make it possible to separate the liquid form of the dihydrogen from the gaseous form of the dihydrogen.

According to one embodiment, the cooling branch comprises an expansion device arranged between an outlet of the second pass of the heat exchanger and an inlet of the gas-liquid separator.

According to one embodiment, the liquefaction device is configured to place a liquid outlet of the gas-liquid separator in fluidic communication with a tank. The fluidic communication between the liquid outlet of the gas-liquid separator and a tank may be ensured by a third portion of the cooling pipe. Thus, the liquefied dihydrogen may be returned to the tank from which the gaseous dihydrogen was taken or it may be sent to a tank for storing dihydrogen in the liquid state that is different from the tank from which the gaseous dihydrogen was taken.

According to one embodiment, a gas outlet of the gas-liquid separator is in fluidic communication with the cooling branch before an inlet of the third pass of the heat exchanger. More specifically, the fluidic communication between the gas outlet of the gas-liquid separator is ensured by a connecting branch connecting the gas outlet of the gas-liquid separator and a junction point arranged on the cooling branch. The junction point is before an inlet of the third pass of the heat exchanger. Consequently, the gaseous phase of the dihydrogen in the gas-liquid separator may be sent to the cooling branch in order to be put to profitable use there.

According to one embodiment, the liquefaction device comprises a bypass branch connecting a convergence point arranged on the supply branch before an inlet of the first pass of the heat exchanger and a junction point arranged on the cooling branch before the compression member (25).

According to one embodiment, the junction point is arranged on the cooling branch before an inlet of the third pass of the heat exchanger. In other words, the convergence point is between a gas outlet of a tank from which the gaseous dihydrogen is taken and the heat exchanger, when the dihydrogen circulates in the cooling branch. This makes it possible in particular to use dihydrogen coming from the same tank as that circulating in the supply branch.

According to one embodiment, the junction point is arranged on the cooling branch between an outlet of the third pass of the heat exchanger and an inlet of the compression member.

According to one embodiment, a fourth pass of the heat exchanger constitutes the bypass branch.

According to one embodiment, the fourth pass of the heat exchanger is arranged so as to exchange heat energy with the second pass and the third pass of the heat exchanger. Thus, the second pass of the heat exchanger is disposed so as to exchange heat energy with the first pass of the heat exchanger and the fourth pass of the heat exchanger. One of the advantages of such an architecture is to cool the dihydrogen coming from the bypass branch and passing through the fourth pass of the heat exchanger before being mixed with the dihydrogen coming from the connecting branch and passing through the third pass of the heat exchanger. Colder dihydrogen is thus obtained at the inlet of the second pass. The reliquefaction efficiency of the liquefaction device is therefore improved. In addition, the energy consumption of the liquefaction device is decreased.

Another subject of the invention is a structure, in particular a floating or onshore structure, comprising at least one tank intended for transporting and/or storing dihydrogen in the liquid state, the structure comprising at least one consumer of dihydrogen as fuel and at least one liquefaction device having at least one of the features described above, the at least one consumer being configured to be supplied with fuel by the dihydrogen in the gaseous state circulating at least in part in said liquefaction device. The consumer may for example be a motor comprising at least one fuel cell. The tank may form a reservoir of fuel for the consumer.

According to one embodiment, a flow of the dihydrogen in the first pass of the heat exchanger is oriented in a direction opposite to a flow of the dihydrogen in the second pass of the heat exchanger. In other words, when the dihydrogen circulates in the liquefaction device, the flow of the dihydrogen in the first pass of the heat exchanger occurs countercurrent to the flow of the dihydrogen in the second pass. Thus, the exchanges of heat energy between the first pass and the second pass of the heat exchanger are increased.

According to one embodiment, a flow of the dihydrogen in the first pass of the heat exchanger is oriented in the same direction as a flow of dihydrogen in the third pass of the heat exchanger. In other words, when the dihydrogen circulates in the liquefaction device, the flow of the dihydrogen in the first pass of the heat exchanger is cocurrent to the flow of the dihydrogen in the third pass. In this context, it is understood that the flow of dihydrogen in the third pass of the heat exchanger is countercurrent to the flow of the dihydrogen in the second pass.

According to one embodiment, a flow of dihydrogen in the fourth pass of the heat exchanger is oriented in the same direction as a flow of dihydrogen in the third pass. In other words, when the dihydrogen circulates in the liquefaction device, the flow of the dihydrogen in the fourth pass of the heat exchanger is cocurrent to the flow of the dihydrogen in the third pass. In this context, it is understood that the flow of dihydrogen in the fourth pass of the heat exchanger is countercurrent to the flow of the dihydrogen in the second pass.

The invention also proposes a transfer system for dihydrogen in the liquid state, the system having a structure having at least one of the preceding features, insulated pipelines arranged so as to connect the tank installed on the structure, in particular in the hull of the structure, to a floating or onshore storage facility and a pump for driving a stream of cold liquid product through the insulated pipelines from or to the floating or onshore storage facility to or from the tank of the structure.

The invention also offers a method for loading or offloading from a structure having at least one of the preceding features, during which dihydrogen in the liquid state is conveyed through the insulated pipelines from or to a floating or onshore storage facility to or from the tank of the structure.

The invention also proposes a method for liquefying gaseous dihydrogen resulting from the evaporation of dihydrogen in the liquid state stored in at least one tank by a liquefaction device having at least one of the features described above, the method comprising at least a step of compression of the gaseous dihydrogen, a step of exchange of heat energy between the compressed gaseous dihydrogen and gaseous dihydrogen withdrawn from the tank so that the compressed gaseous dihydrogen is liquefied, the conversion, in the presence of the catalyst, of the para isomer into the ortho isomer for the withdrawn gaseous dihydrogen occurring during the step of exchange of heat energy.

According to one embodiment, the liquefaction method comprises a step of compression of the gaseous dihydrogen withdrawn from the tank after the step of exchange of heat energy in order to supply a consumer with dihydrogen.

Further features and advantages of the invention will become more apparent both from the following description and from a plurality of non-limiting exemplary embodiments that are given by way of indication with reference to the attached schematic drawings, in which:

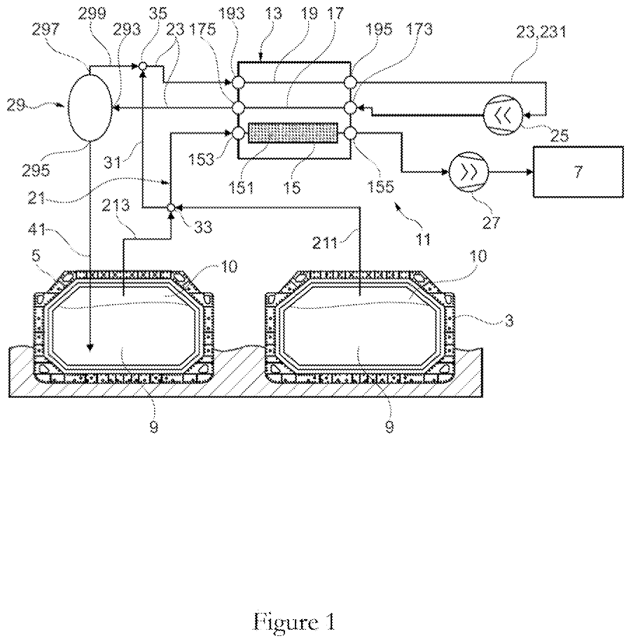

FIG. 1 is a schematic depiction of a first embodiment of a liquefaction device according to the invention, the liquefaction device being configured to liquefy gaseous dihydrogen resulting from the evaporation of dihydrogen in the liquid state stored in at least one tank of a floating structure;

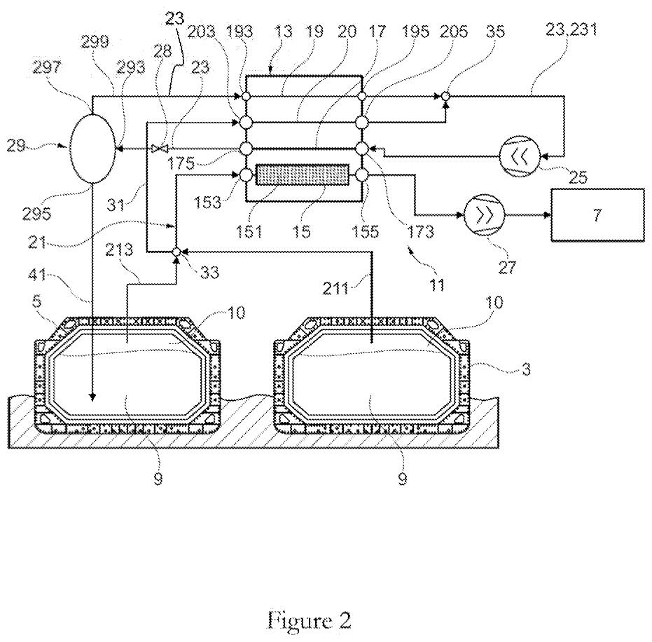

FIG. 2 is a schematic depiction of a second embodiment of a liquefaction device according to the invention, the liquefaction device being configured to liquefy gaseous dihydrogen resulting from the evaporation of dihydrogen in the liquid state stored in at least one tank of a floating structure;

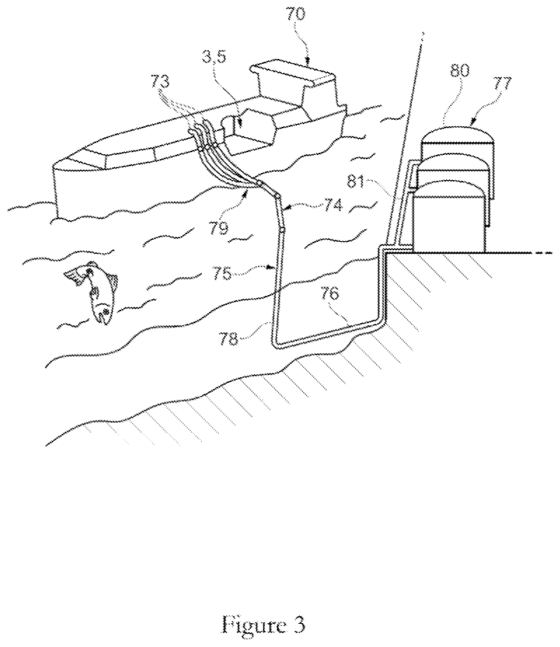

FIG. 3 is a cutaway schematic depiction of the floating structure for transporting liquid dihydrogen in FIG. 1 and of a terminal for loading/offloading the tanks of the floating structure.

It should first of all be noted that, although the figures set out the invention in detail for its implementation, they may of course be used to better define the invention if necessary. It should also be noted that, in all of the figures, elements that are similar and/or perform the same function are indicated using the same numbering.

FIG. 1 depicts a device 11 for liquefying liquid dihydrogen stored in at least one tank 3, 5 of a floating structure for transporting and/or storing dihydrogen. The liquefaction device 11 is configured to cooperate with the tanks 3, 5 and with at least one consumer 7 of the floating structure.

The one or more tanks 3, 5 contain dihydrogen in liquid form 9, i.e. dihydrogen in the liquid state. Since the thermal insulation of the tanks is not perfect, a part dihydrogen in the liquid state 9 evaporates naturally. Therefore, the tanks 3, 5 of the floating structure comprise both dihydrogen in liquid form 9 and dihydrogen in gaseous form 10.

The liquefaction device 11 supplies the consumer 7 with dihydrogen coming from at least one of the tanks 3, 5. By way of example, the consumer 7 comprises at least one fuel cell, but it could also be a combustion engine or turbine.

The liquefaction device 11 comprises at least one heat exchanger 13 with a plurality of passes 15, 17, 19, at least one supply branch 21 configured to bring at least a portion of the gaseous dihydrogen 10 from one of the tanks 3, 5 to the gaseous dihydrogen consumer 7 and at least one cooling branch 23 configured to liquefy at least a part of the gaseous dihydrogen 10 from one of the tanks 3, 5.

A first part of the supply branch 21 passes through the heat exchanger 13 via a first pass 15 inside which is disposed a catalyst 151 involved in the conversion of the para isomer of the dihydrogen into ortho isomer of the dihydrogen. The catalyst 151 is chosen from among gels of nickel, copper, iron or metal hydride, nickel, copper or iron films, iron, cobalt, nickel, chromium, manganese hydroxides, iron oxides, nickel-silicon complexes, activated charcoal and/or at least one combination thereof.

The supply branch 21 comprises at least one compression device 27 arranged on a second part of the supply branch 21 that connects an outlet of the first pass 15 of the heat exchanger 13 to the dihydrogen consumer 7. The compression device 27 is therefore disposed on the supply branch after an outlet 155 of the first pass 15, i.e. downstream thereof, in the direction of circulation of the dihydrogen in the supply branch 21.

The supply branch 21 comprises a third part that connects at least one tank 3, 5 for storing dihydrogen to an inlet 153 of the first pass 15 such that the gaseous dihydrogen 10 retained in at least one of the tanks 3, 5 can flow in the supply branch 21 to the consumer 7.

The third part of the supply branch 21 comprises a first sub-branch 211 connected to a first tank 3 and a second sub-branch 213 connected to a second tank 5. The first sub-branch 211 and the second sub-branch 213 meet at a convergence point 33 of the supply branch 21 that is connected to the inlet 153 of the first pass 15 of the heat exchanger 13 by a connecting pipe.

The supply branch 21 may comprise a valve placed at the convergence point 33 in order to make it possible to choose the provenance of the gaseous dihydrogen, i.e. select the gaseous dihydrogen 10 from the first tank 3 and/or the gaseous dihydrogen 10 from the second tank 5.

The gaseous dihydrogen 10 coming from at least one of these tanks 3, 5 is placed in forced circulation in the supply branch 21 by the compression device 27. The gaseous dihydrogen then flows from the tank to the inlet 153 of the first pass 15 of the heat exchanger 13, then passes through the first pass 15 of the heat exchanger 13.

By flowing from the inlet 153 of the first pass 15 to the outlet 155 of the first pass, the dihydrogen will exchange heat energy with a second pass 17 of the heat exchanger 13. The gaseous dihydrogen flowing in the first pass 15 will then be heated. By way of example, the gaseous dihydrogen has a temperature of −240° C. at 1.1 bar absolute at the inlet 153 of the first pass 15 and a temperature of +25° C. at 1.1 bar at the outlet 155 of the first pass 15.

The presence of the catalyst 151 inside the first pass 15 of the heat exchanger 13 makes it possible to accelerate the reaction of isomerization of the parahydrogen into orthohydrogen, such a reaction being endothermic. Thus, the gaseous dihydrogen circulating in the first pass 15 may absorb even more heat energy coming from the second pass 17 of the heat exchanger 13. The transfer of heat from the second pass 17 to the first pass 15 is greatly increased.

With reference to FIG. 1, the cooling branch 23 has at least one dihydrogen compression member 25. A first portion of the cooling branch 23 passes through the heat exchanger 13 via a second pass 17 disposed after the compression member 25. The gaseous dihydrogen that circulates in the cooling branch 23 is thus compressed by the compression member 25, before it is cooled within the second pass 17, as has been explained above. This increase in pressure promotes the liquefaction of the dihydrogen within the second pass 17, and subsequent thereto.

As is illustrated in FIG. 1, but in an optional manner, a second portion of the cooling branch 23 passes through the heat exchanger 13 via a third pass 19. An outlet 195 of the third pass 19 is connected to the inlet 173 of the second pass 17 by a connecting portion 231 of the cooling branch 23. The connecting portion 231 bears the compression member 25.

The second pass 17 of the heat exchanger 13 is arranged so as to exchange heat energy with the first pass 15 and the third pass 19 of the heat exchanger 13.

The liquefaction device 11 also comprises a bypass branch 31 connecting the convergence point 33 of the supply branch 21 and a junction point 35 arranged on the cooling branch 23. This makes it possible in particular to make the gaseous dihydrogen from one and the same tank circulate in the supply branch 21 and in the cooling branch 23. The junction point 35 is disposed before the compression member 25. More specifically, in the first embodiment depicted in FIG. 1, the junction point is arranged before the inlet 193 of the third pass 19 of the heat exchanger 13.

The gaseous dihydrogen 10 coming from at least one of the tanks flows from one of the tanks 3, 5 to the inlet 193 of the third pass 15 of the heat exchanger 13 and then passes through the third pass 19 of the heat exchanger 13.

At the outlet 195 of the third pass 19, the dihydrogen is compressed by the compression member 25 and sent to the inlet 173 of the second pass of the heat exchanger 13. In other words, the pressure of the dihydrogen after its passage through the compression member 25 is greater than the pressure of the dihydrogen before its passage through the compression member 25.

In this context, it is understood that the compression member 25, as a result of its function, allows the forced circulation of the gaseous dihydrogen 10 coming from at least one of the tanks 3, 5 in the cooling branch 23 through the compression member 25.

Then, the compressed dihydrogen flows in the second pass 17 of the heat exchanger 13 where it gives up heat energy to the dihydrogen flowing in the third pass 19 of the heat exchanger 13 and to the dihydrogen flowing in the first pass 15 of the heat exchanger 13. The dihydrogen circulating in the second pass 17 will therefore change state, so as to at least partially transition to the liquid state. Thus, at the outlet 175 of the second pass 17 of the heat exchanger 13, at least a part of the dihydrogen is liquefied, preferentially all the dihydrogen is liquefied.

In order to optimize the exchanges of heat energy between the passes 15, 17 of the heat exchanger 13, the flow of dihydrogen in the second pass 17 occurs countercurrent to the flow of dihydrogen in the first pass 15. In order to further improve the transfer of heat between the passes 17, 19 of the heat exchanger 13, the flow of dihydrogen in the second pass 17 occurs countercurrent to the flow of dihydrogen in the third pass 19. It will be understood that the dihydrogen in the first pass 15 flows in the same direction as the direction of circulation of the dihydrogen within the third pass 19.

By way of example, the dihydrogen has a temperature of −250° C. at the inlet 193 of the third pass 19 of the heat exchanger 13 and a temperature of +25° C. at the outlet 195 of the third pass 19 of the heat exchanger 13. The compression member 25 compresses the dihydrogen to a pressure of between 35 and 45 bar for a temperature of +43° C. The dihydrogen has a temperature of +43° C. at the inlet 173 of the second pass 17 of the heat exchanger 13 and a temperature of −240° C. at the outlet 175 of the second pass 17 of the heat exchanger 13.

At the outlet 175 of the second pass 17 of the heat exchanger 13, the dihydrogen is at least partially liquefied. In other words, the dihydrogen may have a liquid phase and a gaseous phase after having passed through the second pass 17 of the heat exchanger 13. The two phases are then mixed.

In the embodiment depicted in FIG. 1, the liquefaction device 11 comprises a gas-liquid separator 29 arranged on the cooling branch 23. The separator is arranged after the outlet 175 of the second pass 17. After having left the second pass 17 of the heat exchanger 14, the at least partially liquefied dihydrogen flows toward an inlet 293 of the gas-liquid separator 29.

An expansion device, not depicted in this first embodiment, may be arranged between the outlet 175 of the second pass 17 and the inlet 293 of the gas-liquid separator 29 so as to decrease the pressure of the fluid entering the gas-liquid separator 29.

A liquid outlet 295 of the gas-liquid separator 29 is in fluidic communication with at least one of the tanks 3, 5, such fluidic communication being ensured by a third portion 41 of the cooling pipe 23.

A gas outlet 297 of the gas-liquid separator 29 is in fluidic communication with the cooling branch 23 before an inlet 193 of the third pass 19 of the heat exchanger 13. By way of example, the dihydrogen has a temperature of −254° C. at the gas outlet 297 of the gas-liquid separator 29.

The fluidic communication of the gas outlet 297 of the gas-liquid separator 29 with the cooling branch 23 is ensured by a connecting branch 299 connecting the gas outlet 297 of the gas-liquid separator 29 with the junction point 35 arranged on the cooling branch 23.

When the dihydrogen circulates in the liquefaction device 11, after having left the second pass 17 of the heat exchanger 13, the dihydrogen is sent to the gas-liquid separator 29 so that the liquid phase of the dihydrogen is separated from the gaseous phase.

The liquid phase of dihydrogen contained in the gas-liquid separator 29 may be sent to the liquid phase 9 of the dihydrogen stored in one of the tanks 3, 5 via the third portion 41 of the cooling pipe 23. The gaseous phase of dihydrogen contained in the gas-liquid separator 29 may be introduced into the cooling branch 23 at the junction point 35 via the connecting branch 299 so as to be liquefied there.

FIG. 2 illustrates a second embodiment of the liquefaction device according to the invention. The second embodiment differs from the first embodiment in that the junction point 35 is between the outlet 195 of the third pass 19 and the compression member 25 on the cooling branch 23, and in that the bypass branch 31 passes through the heat exchanger 13 via a fourth pass 20. Identical elements are denoted by the same references. Reference may be made to the description above for further details on these identical elements.

With reference to FIG. 2, the fourth pass 20 of the heat exchanger 13 constitutes the bypass branch 31 that connects the convergence point 33 and the junction point 35. The convergence point 31 is on the supply branch 21 before the inlet 153 of the first pass 15.

The junction point 35 is on the cooling branch 23. The junction point 35 is disposed between before the compression member 25. As is depicted in FIG. 2, the junction point 35 is arranged between the outlet 195 of the third pass 19 and the inlet 173 of the second pass 17, more specifically before an inlet of the compression member 25.

The gas outlet 297 of the gas-liquid separator 29 is in fluidic communication with the inlet 193 of the third pass 19 via the connecting branch 299. The connecting branch 299, in this second embodiment, constitutes the second portion of the cooling branch 23. Thus the dihydrogen entering the third pass 19 has a temperature identical to the gaseous phase of dihydrogen leaving the gas-liquid separator 29, i.e. −254° C. in this second embodiment.

The fourth pass 20 of the heat exchanger 13 constitutes the bypass branch 31. The fourth pass 20 is arranged so as to exchange heat energy with the second pass 17 and the third pass 19 of the heat exchanger 13. Therefore, the second pass 17 of the heat exchanger 13 is disposed so as to exchange heat energy with the first pass 15 of the heat exchanger 13 and the fourth pass 20 of the heat exchanger 13.

With reference to FIG. 2, a flow of gaseous dihydrogen in the fourth pass 20 of the heat exchanger 13 is oriented in the same direction as a flow of gaseous dihydrogen in the third pass 19. In other words, when the gaseous dihydrogen circulates in the liquefaction device 11, the flow of the dihydrogen in the fourth pass 20 of the heat exchanger 13 is cocurrent to the flow of the dihydrogen in the third pass 19. Furthermore, the flow of gaseous dihydrogen in the fourth pass 20 of the heat exchanger 13 is countercurrent to the flow of the dihydrogen in the second pass 17.

When the liquefaction device 1 according to the second embodiment illustrated in FIG. 2 is passed through by dihydrogen, the dihydrogen leaves the second pass 17 of the heat exchanger 13 in a compressed and cooled state. Thus, when the dihydrogen in the cooling pipe 23 enters the gas-liquid separator 29, it undergoes expansion that consequently creates a liquid phase of dihydrogen and a gaseous phase of dihydrogen in the gas-liquid separator 29.

An expansion device 28 may, in an optional manner, be arranged between the outlet 175 of the second pass 17 and the inlet 293 of the gas-liquid separator 29 so as to decrease the pressure of the fluid entering the gas-liquid separator 29.

The liquid phase of dihydrogen in the gas-liquid separator 29 may be returned to one of the tanks 3, 5. More specifically, the liquid phase of dihydrogen is directly delivered to the liquid phase 9 contained in the tank 5 via the third portion 41 of the cooling pipe 23 that extends from the liquid outlet 295 of the gas-liquid separator 29 into the tank 5 such that one end of the third portion 41 is immersed in the liquid dihydrogen contained in the tank 5.

The gaseous phase of dihydrogen in the gas-liquid separator 29 is, for its part, sent to the cooling branch 23, passing through the third pass 19 of the heat exchanger 13.

The dihydrogen at the inlet 193 of the third pass 19 of the heat exchanger 13, which is in the gaseous state coming from the gas-liquid separator 29, is colder than the dihydrogen at the inlet 203 of the fourth pass 20. The second embodiment then makes it possible to profit from the heat energy absorption capacity of the gaseous phase coming from the gas-liquid separator 29 by virtue of the fourth pass 20 of the heat exchanger 13.

Thus, the dihydrogen at the outlet 195 of the third pass 19 is colder than in the case of the first embodiment, in which the liquefaction device 1 does not have a fourth pass. The dihydrogen at the inlet 173 of the second pass 17 in this second embodiment is therefore colder and will therefore be cooled even more at the outlet 175 of the second pass 17 than in the first embodiment.

In this second embodiment, since the dihydrogen is colder at the outlet 175 of the second pass 17 than in the first embodiment, it creates less gaseous phase in the gas-liquid separator 29. Therefore, the quantity of dihydrogen to be recycled via the connecting branch 299 is smaller and the energy consumption of the liquefaction device is decreased compared with the first embodiment.

With reference to FIG. 3, a cutaway view of a floating structure 70 shows a sealed and thermally insulating tank 3, 5 of prismatic overall shape mounted in a double hull 72 of the floating structure 70, which may be a ship or a floating platform. A wall of the tank 3, 5 has a primary sealing barrier intended to be in contact with the dihydrogen in the liquid state contained in the tank 3, 5, a secondary sealing barrier arranged between the primary sealing barrier and the double hull 72 of the ship, and two thermally insulating barriers arranged between the primary sealing barrier and the secondary sealing barrier and between the secondary sealing barrier and the double hull 72, respectively. In a simplified version, the floating structure 70 has a single hull. Alternatively, the dihydrogen tanks are spherical tanks insulated under vacuum.

Loading/offloading pipelines 73 disposed on an upper deck of the floating structure 70 can be connected, by means of appropriate connectors, to a maritime or port terminal in order to transfer a cargo of dihydrogen in the liquid state from or to the tank 3, 5.

FIG. 3 depicts an example of a maritime terminal having a loading and/or offloading station 75, an underwater pipe 76 and an onshore facility 77. The loading and/or offloading station 75 is a fixed offshore facility having a mobile arm 74 and a tower 78 that supports the mobile arm 74. The mobile arm 74 bears a bundle of insulated flexible hoses 79 that can be connected to the loading/offloading pipelines 73. The mobile arm 74 is orientable and adapts to all sizes of floating structure 70. A connecting pipe (not shown) extends inside the tower 78. The loading and/or offloading station 75 allows the floating structure 70 to be loaded and/or offloaded from or to the onshore facility 77. The latter has tanks for storing dihydrogen in the liquid state 80 and connecting pipes 81 connected by the underwater pipe 76 to the loading and/or offloading station 75. The underwater pipe 76 allows the transfer of the dihydrogen in the liquid state between the loading and/or offloading station 75 and the onshore facility 77 over a long distance, for example 5 km, and this makes it possible to keep the floating structure 70 at a long distance from the coast during the loading and/or offloading operations.

In order to generate the pressure necessary for the transfer of the dihydrogen, pumps on board the floating structure 70 and/or pumps with which the onshore facility 77 is equipped and/or pumps with which the loading and offloading station 75 is equipped are used. Alternatively, the dihydrogen may be offloaded via pressure effect, i.e. by increasing the pressure in the tank 3, 5. Thus, the dihydrogen may be offloaded without a pump.

Of course, the invention is not limited to the examples that have just been described, and numerous modifications may be made to these examples without departing from the scope of the invention. For example, the two embodiments of the liquefaction device according to the invention have been described in the context of a floating structure. However, they could be implemented in an onshore structure.

1. A device for liquefying gaseous dihydrogen resulting from the evaporation of dihydrogen in the liquid state stored in at least one tank, the liquefaction device comprising at least one heat exchanger with a plurality of passes, at least one supply branch configured to bring at least a portion of the gaseous dihydrogen from the tank to a gaseous dihydrogen consumer, a part of the supply branch passing through the heat exchanger via a first pass inside which is disposed a catalyst involved in the conversion of the para isomer of the dihydrogen into ortho isomer of the dihydrogen, the liquefaction device comprising at least one cooling branch configured to liquefy at least a part of the gaseous dihydrogen, the cooling branch having at least one compression member, a portion of the cooling branch passing through the heat exchanger via a second pass disposed after the compression member, the second pass exchanging heat energy with the first pass in order to liquefy at least a part of the dihydrogen circulating in the cooling branch.

2. The liquefaction device as claimed in the claim 1, wherein the catalyst is chosen from among gels of nickel, copper, iron or metal hydride, nickel, copper or iron films, iron, cobalt, nickel, chromium, manganese hydroxides, iron oxides, nickel-silicon complexes, activated charcoal and/or at least one combination thereof.

3. The liquefaction device as claimed in claim 1, wherein the supply branch comprises a compression device arranged after an outlet of the first pass.

4. The liquefaction device as claimed in claim 1, wherein another portion of the cooling branch passes through the heat exchanger via a third pass, an outlet of the third pass being connected to an inlet of the second pass by a connecting portion of the cooling branch, the connecting portion comprising the compression member.

5. The liquefaction device as claimed in claim 4, wherein the second pass of the heat exchanger is arranged so as to exchange heat energy with the first pass and the third pass of the heat exchanger.

6. The liquefaction device (H) as claimed in claim 1, comprising a gas-liquid separator arranged on the cooling branch after an outlet of the second pass.

7. The liquefaction device as claimed in claim 6, configured to place a liquid outlet of the gas-liquid separator in fluidic communication with a tank.

8. The liquefaction device as claimed in claim 4, comprising a gas-liquid separator arranged on the cooling branch after an outlet of the second pass, wherein a gas outlet of the gas-liquid separator is in fluidic communication with the cooling branch before an inlet of the third pass of the heat exchanger.

9. The liquefaction device as claimed in any one of the preceding claims taken in combination with claim 4, comprising a bypass branch connecting a convergence point arranged on the supply branch before an inlet of the first pass of the heat exchanger and a junction point arranged on the cooling branch before the compression member.

10. A structure intended for transporting and/or storing dihydrogen in the liquid state that comprises at least one tank containing liquid dihydrogen, the floating structure comprising at least one dihydrogen consumer and at least one liquefaction device as claimed in claim 1, the at least one consumer being configured to be supplied with fuel by the dihydrogen the gaseous state circulating at least in part in said liquefaction device.

11. The structure as claimed in claim 10, wherein a flow of the dihydrogen in the first pass of the heat exchanger is oriented in a direction opposite to a flow of the dihydrogen in the second pass of the heat exchanger.

12. The structure as claimed in claim 10, wherein another portion of the cooling branch passes through the heat exchanger via a third pass an outlet of the third pass being connected to an inlet of the second pass by a connecting portion of the cooling branch, the connecting portion comprising the compression member and wherein a flow of the dihydrogen in the first pass of the heat exchanger is oriented in the same direction as a flow of dihydrogen in the third pass of the heat exchanger.

13. A transfer system for dihydrogen in the liquid state, the system having a structure as claimed in claim 10, insulated pipelines arranged so as to connect the tank installed on the structure to a floating or onshore storage facility and a pump for driving a stream of cold liquid product through the insulated pipelines from or to the floating or onshore storage facility to or from the tank of the structure.

14. A method for loading or offloading from a structure as claimed in claim 10, during which dihydrogen in the liquid state is conveyed through the insulated pipelines from or to a floating or onshore storage facility to or from the tank of the structure.

15. A method for liquefying gaseous dihydrogen resulting from the evaporation of dihydrogen in the liquid state stored in at least one tank a liquefaction device as claimed in claim 1, the method comprising a step of compression of the gaseous dihydrogen by the compression member and a step of exchange of heat energy in the heat exchanger between the compressed gaseous dihydrogen and gaseous dihydrogen withdrawn from the tank, so that the compressed gaseous dihydrogen is at least partially liquefied, the conversion, in the presence of the catalyst, of the para isomer into the ortho isomer for the withdrawn gaseous dihydrogen occurring during the step of exchange of heat energy.
